(19) United States
(12) Patent Application Publication
(10) Pub. No.: US 2015/0079231 A1
(43) Pub. Date: Mar. 19, 2015

(54) METHOD FOR INHIBITING AGGREGATE FORMATION DURING PROTEIN HYDROLYSIS

(71) Applicants: Brent L. Petersen, Twin Falls, ID (US); Loren S. Ward, Twin Falls, ID (US)

(72) Inventors: Brent L. Petersen, Twin Falls, ID (US); Loren S. Ward, Twin Falls, ID (US)

(73) Assignee: GLANBIA NUTRITIONALS (IRELAND) PLC, Kilkenny (IE)

(21) Appl. No.: 14/488,218

(22) Filed: Sep. 16, 2014

Related U.S. Application Data
(60) Provisional application No. 61/878,102, filed on Sep. 16, 2013.

(51) Int. Cl. A23J 3/22; A23J 3/34

(52) U.S. Cl. CPC A23J 3/222; A23J 3/344
USPC 426/42; 426/580; 435/68.1

(57) ABSTRACT

Disclosed is for inhibiting gel formation during, or resulting from, hydrolysis of protein compositions comprising casein.

### FIELD OF THE INVENTION

The invention relates to methods for inhibiting protein aggregate formation during, or resulting from, protein hydrolysis.

### BACKGROUND OF THE INVENTION

Hydrolysis of proteins cleaves peptide bonds to give peptides of various sizes and amino acid composition. Hydrolysis may bring out certain desirable properties of some proteins. For example, soy protein hydrolyzed with Flavourzyme® (Novo Nordisk A/S Corp., Denmark) or chymotrypsin demonstrates greater antioxidant potential than does intact soy protein isolate, and reduction of the secondary structure of protein of either plant or animal origin, with enzymatic release of smaller polypeptide units, may result in increased solubility of hydrolysates compared to that of the original intact protein.

Hydrolysis to peptides and/or polypeptides may also reduce undesirable properties that were noted in the full-length protein. For example, one of the beneficial aspects of milk protein hydrolysates is that they tend to be less antigenic than the proteins from which they were derived. Approximately two to five percent of formula-fed infants develop cow's milk protein allergy (CMPA), which can be quite serious. However, extensively-hydrolyzed formulas derived from casein and/or whey have been reported to be about ninety percent (90%), effective in mitigating the antigenic effect in infants with CMPA (Brill, Herbert. Approach to Milk Protein Allergy in Infants, Can. Fam. Physician, 2008 (September) 54(9): 1258-1264).

There are two general categories of protein hydrolysis that are commonly used: enzymatic and chemical (e.g., acid or alkali). Chemical hydrolysis can be more difficult to control and may have the potential to reduce the nutritional quality of the resulting hydrolysates. Enzymes, on the other hand, generally hydrolyze proteins under milder conditions of temperature and pH than those which are used in alkaline or acid hydrolysis, and can target specific peptide bonds. Protein hydrolysis in the food industry generally involves the use of digestive proteolytic enzymes from animals (e.g. trypsin, pepsin, chymotrypsin) and/or food-grade enzymes from plants or microorganisms (e.g., bacteria, fungi).

Protein hydrolysis can be complicated by undesired molecular interactions, such as formation of insoluble protein aggregates, or gels. For example, although the coagulation and precipitation of casein during enzymatic hydrolysis is a desirable thing in cheese-making, it can be a major complication when those same proteins are hydrolyzed for use as ingredients in products such as beverages. In those situations, the tendency to form insoluble aggregates is a problem for which a solution needs to be found. It would therefore be beneficial to find a method whereby proteins such as casein could be hydrolyzed to varying degrees without the development of aggregates.

### SUMMARY OF THE INVENTION

The invention relates to a method for inhibiting gel formation during, or resulting from, enzymatic hydrolysis of protein compositions comprising casein, the method comprising the step of admixing at least one protein composition comprising casein with at least one protease and maintaining the protein composition and at least one protease at a temperature of from about 6° C. to about 8° C. for a time interval sufficient to inhibit subsequent aggregate formation when the temperature of the admixture is increased as, for example, may generally be done to utilize the protease(s) at an optimum temperature and increase the rate of hydrolysis. In various aspects, the at least one protein composition is admixed with the at least one protease in an aqueous solution, with a solids concentration of from about five (5) to about thirty (30) percent solids.

In various aspects, the at least one protease is selected from the group consisting of proteases of animal, plant, bacterial, and fungal origin, and combinations thereof. Among the various embodiments of the method, the at least one protease can be selected from the group consisting of Bromelain, Papain, Trypsin, Chymotrypsin, and combinations thereof, and/or from the group consisting of proteases from Bacillus species, proteases from Aspergillus species, and combinations thereof.

The method may be applied to the hydrolysis of protein compositions comprising casein such as, for example, milk protein isolate and milk protein concentrate, and the casein may include, for example, sodium caseinate, calcium caseinate, and potassium caseinate, and combinations thereof.

In various aspects of the method, the time interval sufficient to inhibit gel formation is at least about 6 hours and may be, for example, from about 13 to about 17 hours, (those of skill in the art understanding that the time may be dependent upon enzyme concentration and substrate concentration,) with the time interval being readily determined by one of skill in the art as that amount of time required to inhibit aggregate formation when the enzyme/protein admixture temperature is raised, or the admixture is heated to a temperature that is normally considered an effective temperature range for a particular enzyme (protease), or mixture thereof, those ranges varying to some degree, depending upon the enzyme(s) selected.

Also provided is a method for producing a hydrolyzed milk protein isolate or milk protein concentrate, the method comprising admixing a milk protein composition selected from the group consisting of milk protein concentrate, milk protein isolate, and combinations thereof, with at least one protease; maintaining the admixture of milk protein product and at least one protease at a temperature of from about 4 degrees to about 10 degrees Celsius for a period sufficient to inhibit aggregate formation in the admixture when the temperature is increased; inactivating the protease; and spray-drying the hydrolyzed milk protein product.

Generally, various aspects of the methods above involve admixing of the protein starting material with the at least one protease in an aqueous solution, and the at least one protease is selected from the group consisting of at least one animal protease, at least one plant protease, at least one bacterial protease, at least one fungal protease, and combinations thereof. Various embodiments of the invention may utilize proteases selected from the group consisting of Bromelain, Papain, Trypsin, Chymotrypsin, and combinations thereof, or the group consisting of proteases from Bacillus species, proteases from Aspergillus species, and combinations thereof.

The invention also provides a hydrolyzed milk protein product prepared by a method comprising: admixing a milk protein composition selected from the group consisting of milk protein concentrate, milk protein isolate, and combinations thereof, with at least one protease; maintaining the admixture of the milk protein composition and at least one protease at a temperature of from about 6 degrees to about 8 degrees for a time interval sufficient to inhibit gel formation; hydrolyzing the milk protein composition to form a hydrolyzed milk protein product; inactivating the protease; and spray-drying the hydrolyzed milk protein product.

### BRIEF DESCRIPTION OF THE DRAWINGS

FIG. 1 is a photograph of a gel, illustrating that the method of the invention produces an MPC 85 (milk protein concentrate) hydrolysate. The first lane contains an Alpha Casein standard containing both α s1 and α s2. The second lane contains the Beta Casein standard, and the third lane has the MPC 85 hydrolysate showing hydrolyzed casein. The last lane contains a typical MPC 85 control product.

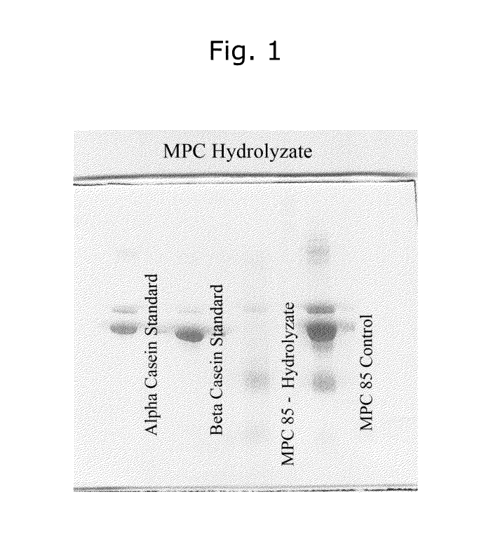

### DETAILED DESCRIPTION

Caseins are a family of related phosphoproteins that make up about eighty percent of the protein in bovine milk. It is well known in the art of cheese-making that milk and casein-based products such as milk protein isolate and milk protein concentrate will gel and form aggregates. In fact, this is a desired reaction that cheese makers have used for many centuries and it is well known that protease addition is critical for coagulation and curd formation. Conditions for curd formation and coagulation have been optimized and many such optimization studies have been reported in the literature. However, for many other applications it is desirable to hydrolyze milk proteins without gelation and coagulation so that the liquid product can be spray-dried and utilized in a wide variety of methods and products. Preventing coagulation and aggregation permits the proteins to remain soluble so that they can be spray-dried.

The inventors have discovered that holding at least one protein composition comprising casein in the presence of at least one protease at a temperature of from about 2 to about 10 degrees Celsius for a time interval sufficient to inhibit coagulation (that would generally have been initiated by enzymatic hydrolysis at a higher temperature), allows the protein to be hydrolyzed without the formation of aggregates (e.g., curds and/or gels). Given the disclosure provided herein, the time interval may readily be determined by one of skill in the art without undue experimentation, the time interval being dependent, to some degree, on the selected protease and the amount of protease utilized. Generally, such a time interval may be at least about 6 hours, although in certain circumstances it may be less (e.g., about 2 hours). For hydrolysis of milk protein concentrate using Debitrase® HYW20 (DSM), for example, the inventors determined that a time of from about 13 to 17 hours was quite effective. The temperature may be determined by those of skill in the art as the temperature range in which hydrolysis is not associated with an appreciable degree of aggregation, gelation, etc. Typically, enzymatic hydrolysis would be performed by one of skill in the art within a temperature range that would promote optimum activity of the at least one protease, or a combination of proteases. However, when a protein such as casein is hydrolyzed, this approach can result in formation of aggregates during the hydrolysis process. The inventors have developed a method whereby utilizing a first step comprising holding at least one protein composition comprising casein in the presence of at least one protease at a temperature of from about 2 to about 10 degrees Celsius for an effective time interval will inhibit coagulation that would generally have been expected by enzymatic hydrolysis at a higher temperature. Furthermore, performing this first step allows one of skill in the art to subsequently increase the temperature to within a desired range so that partial or complete hydrolysis can proceed more quickly without producing aggregates. A hydrolyzed milk protein isolate, hydrolyzed milk protein concentrate, or other protein composition comprising casein that is produced by this method may be highly useful for a variety of purposes, including, for example, as an ingredient in protein bars and beverages, in infant formula, in energy drinks, and in protein powders for bodybuilders and other athletes.

While not being bound by theory, the inventors believe that since protein gelation and aggregation can depend on hydrophobic protein interactions, by decreasing the temperature it is possible to decrease those hydrophobic interactions, because they are temperature-dependent. As a result, the inventors have discovered that it is possible to bypass the aggregation phase of heat sensitive proteins and hydrolyze them to a point at which there is no hydrolysis-associated aggregation upon heating. More specifically, the inventors believe that utilizing the enzyme at low temperature may result in a controlled hydrolysis of kappa-casein at cooler temperatures, kappa-casein usually playing a significant role in gel formation in solution. By inhibiting gel formation during this more controlled hydrolysis, the quality and solubility of the resulting hydrolysate is significantly improved. Once a sufficient amount of protein hydrolysis has been achieved during cold hydrolysis without gel formation, it is then possible to increase the temperature to accelerate protein hydrolysis. Additional enzymes, debittering agents, etc., can be added to the solution prior to, concomitantly with, or after increasing the temperature of the solution and the enzyme/protein admixture. With the cold hydrolysis step included, gelation does not occur at the warmer temperatures, whereas when there is no cold hydrolysis step, gelation and curd formation generally occurs.

The inventors believe that the cold-processing step is especially effective if combined with in-line spray-drying so that the product is dried upon completion of the process, without allowing a significant holding time in-between. For example, milk protein concentrates and milk protein isolate are typically stored in refrigerated silos prior to spray drying. By adding enzymes to the refrigerated silos that initial “cold hydrolysis” is accomplished and the product can then be spray dried, or it may be warmed and held for a time to increase the degree of hydrolysis. By controlling these factors, the inventors have produced hydrolyzed milk protein isolates, a hydrolyzed milk protein concentrates, having the properties desired for their use in a variety of products, without having to separately combine component parts to reconstitute a milk protein isolate from isolated whey proteins and isolated casein proteins, preparing sodium caseinates, etc.

In various applications of the method, the protein can be milk casein, milk protein isolate (MPI), milk protein concentrate (MPC) or mixtures thereof. The protein can be in the form of a dried powder that is reconstituted at the beginning of the processing steps or the protein starting material can be purchased as a liquid, which can also comprise previously rehydrated powder. The starting material can be pH adjusted, as needed to accommodate the protease that is selected. Enzyme concentration may be determined by one of skill in the art, depending upon the enzyme selected and the amount of protein used as the starting material. The time for which the admixed protein isolate and enzyme are held under low temperature conditions can also be adjusted by one of skill in the art, given the information provided in the present disclosure, keeping in mind that one goal of the process is to limit the formation of aggregates, especially limiting the significant rate of aggregate formation that occurs at higher temperatures. After an initial period of cold temperature to limit aggregation, the product can be warmed to accelerate hydrolysis activity without aggregation.

Milk Protein Isolate (MPI) is obtained by the partial removal of lactose and minerals from skim milk so that the finished dry product contains about ninety percent (90%) or more protein by weight. Milk Protein Isolate has very high amino acid composition that makes it ideal for use in protein bars and meal replacement powders. Products which are sold as hydrolyzed milk protein isolate are often not produced from the hydrolysis of milk protein isolate, but rather are produced by hydrolyzing various isolated milk protein fractions and recombining them to avoid the challenges associated with gelation, aggregation and precipitation. The additional steps required to produce these products, however, add to the cost and potentially lose some of the beneficial components of MPI in the process. Some hydrolyzed milk products are produced using sodium caseinate, which is itself produced by reacting acid casein curd with sodium hydroxide, sodium caseinate being the most water soluble form of caseinate. Sodium caseinate can then be used as starting material to make a casein hydrolysate. The method of the present invention eliminates the need for such additional steps and processes, making it possible to use milk protein concentrate or milk protein isolate as the starting substrate for the enzyme.

The need to “re-form” milk protein hydrolysates from these separately-isolated protein fractions, or from chemically-altered protein fractions, has arisen because aggregate formation results in reduced solubility of the hydrolyzed protein product. Hydrolyzing MPI or MPC, for example, to produce a product with an acceptable degree of hydrolysis is complicated by the fact that casein micelles and whey proteins interact and, at temperatures commonly used for enzymatic hydrolysis, may rapidly form curds or gels. The present invention allows a formulator to begin with milk protein concentrate or milk protein isolate, for example, and produce a hydrolyzed milk protein concentrate or hydrolyzed milk protein isolate therefrom, the hydrolyzed product having a desirable solubility profile without the need to chemically alter the protein or separately isolate and hydrolyze protein fractions.

As used herein, “protein compositions comprising casein” include milk protein concentrates and milk protein isolates, but may also include other protein compositions which naturally contain casein or to which casein has been added. The amount of casein in such a composition may therefore vary. Where the term “comprising” is used, it is to be understood that such compositions and/or methods may also be described as “consisting of” or “consisting essential of,” as well.

Hydrolyzed milk protein isolates or milk protein concentrates made by the method of the invention provide many benefits associated with the various milk proteins. Whey protein isolates, for example, are commonly used in a variety of products, such as infant formula and nutritional supplements for athletes. The combination of casein and whey that is found originally in milk protein provides certain nutritional advantages that may be important to meet the nutritional goals of infants, athletes, and the elderly, etc. Whey protein is considered to be an excellent source of leucine and total branched-chain amino acids, while casein proteins are higher in arginine and glutamine, both of which are known to play a significant role in the immune system, among their individual and combined beneficial effects.

Extensively hydrolyzed proteins for use in infant formulas may also provide a benefit in that they are more readily digested and absorbed, and may also contain free amino acids. Human milk has been reported to contain free amino acids at a level that is about two to five percent higher than that commonly found in infant formulas.

“Cold temperature hydrolysis” refers to the method described herein of exposing the desired protein isolate or protein concentrate to one or more proteases at a temperature sufficiently low so as to limit aggregate formation while allowing limited protein hydrolysis to occur. Additional steps may be added to the process/method following cold temperature hydrolysis, including the steps of warming an admixture of aqueous protein isolate and enzyme to an appropriate incubation temperature for the selected enzyme, incubating the admixture for a time appropriate for the selected enzyme, and raising the temperature to deactivate the enzyme prior to the spray-drying step.

Another advantage provided by the method of the invention may be the separation (which may aid in isolation) and/or more selective hydrolysis of beta-casein, which is released from the casein micelles under cooler temperatures. Each casein fraction, such as the Alpha- and Beta-casein protein fractions, offers distinct functional and nutritional profiles. By enabling the selective isolation and/or hydrolysis of a particular fraction, it is possible to enrich one or more fractions which may possess unique functional and nutritional properties.

The invention also relates to products made by the method of the invention. Such products may include additional flavorings, coloring, vitamins, minerals, stabilizers, and/or other desired ingredients. These products may be useful for formulating infant formulas having decreased antigenicity for infants with cow's milk protein allergy. These products may be useful for formulating more complete protein panels for protein drinks, protein bars, confectioneries, bakery products, and/or other products to which it may be desirable to add milk protein isolate. The present method provides soluble forms of milk proteins for these uses.

The invention may be further described by means of the following non-limiting examples.

### EXAMPLES

Milk Protein Concentrate 85 was used as a starting material. 600 g was added to 3400 g of water and mixed in a large stainless steel beaker. pH adjustment to 7.3 was performed, and the aqueous admixture was cooled to a temperature of about 7° C. 3 g of Debitrase® HYW20 (Danisco) was added and mixed with the protein to produce a homogenous solution.

The admixture of MPC and enzyme was incubated at 7° C. for a period of about 15 hours, then warmed to a temperature of about 50° C. and further incubated for 1 hour. The admixture was then heated to a temperature of 65° C. to inactivate the enzyme and the aqueous hydrolyzed MPC was then dried by spray-drying with a NiroMobile minor to yield 400 g of dry hydrolyzed milk protein concentrate powder.

What is claimed is:

1. A method for inhibiting protein aggregate formation associated with enzymatic hydrolysis of casein, the method comprising admixing at least one protein composition comprising casein with at least one protease and maintaining the admixture of protein composition and protease at a temperature of from about 6° C. to about 8° C. for a time interval sufficient to inhibit gel formation.

2. The method of claim 1 wherein the time interval sufficient to inhibit gel formation is further defined sufficient to inhibit gel formation when the temperature of the admixed at least one protein composition and at least one protease is increased to increase the rate of hydrolysis of the at least one protein.

3. The method of claim 1 wherein the at least one protein composition is admixed with the at least one protease in an aqueous solution.

4. The method of claim 3 wherein the aqueous solution comprises from about five to about thirty percent solids.

5. The method of claim 1 wherein the at least one protease is selected from the group consisting of proteases of animal, plant, bacterial, and fungal origin, and combinations thereof.

6. The method of claim 1 wherein the at least one protease is selected from the group consisting of Bromelain, Papain, Trypsin, Chymotrypsin, and combinations thereof.

7. The method of claim 1 wherein the at least one protease is selected from the group consisting of proteases from Bacillus species, proteases from Aspergillus species, and combinations thereof.

8. The method of claim 1 wherein the at least one protein composition is selected from the group consisting of milk protein isolate, milk protein concentrate, casein, and combinations thereof.

9. The method of claim 8 wherein the casein is selected from the group consisting of sodium caseinate, calcium caseinate, potassium caseinate, and combinations thereof.

10. The method of claim 1 wherein the time interval sufficient to inhibit gel formation is at least about 6 hours.

11. The method of claim 10 wherein the time interval sufficient to inhibit gel formation is from about 13 to about 17 hours.

12. A hydrolyzed milk protein product prepared by a method comprising:
a) admixing a milk protein composition selected from the group consisting of milk protein concentrate, milk protein isolate, and combinations thereof, with at least one protease;
b) maintaining the admixture of the milk protein composition and at least one protease at a temperature of from about 6 degrees to about 8 degrees for a time interval sufficient to inhibit gel formation;
c) hydrolyzing the milk protein composition to form a hydrolyzed milk protein product;
c) inactivating the protease; and
d) spray-drying the hydrolyzed milk protein product.

13. The product of claim 12 wherein the milk protein composition is admixed with the at least one protease in an aqueous solution.

14. The product of claim 12 wherein the period sufficient to inhibit gel formation is at least about 6 hours.

15. The product of claim 12 wherein the period sufficient to inhibit gel formation is from about 13 to about 17 hours.

16. A method for producing a hydrolyzed milk protein composition comprising casein, the method comprising
a) admixing a milk protein composition comprising casein with at least one protease;
b) maintaining the temperature of the admixed milk protein composition and at least one protease at from about 6 degrees to about 8 degrees for a period sufficient to inhibit gel formation;
c) warming the admixed milk protein composition and at least one protease to an appropriate incubation temperature for the at least one protease and incubating the admixture for a period of at least about 30 minutes;
c) inactivating the at least one protease; and
d) spray-drying the hydrolyzed milk protein composition.

17. The method of claim 18 wherein the milk protein composition is admixed with the at least one protease in an aqueous solution.

18. The method of claim 18 wherein the period sufficient to inhibit gel formation is at least about 6 hours.
